(19) United States
(12) Patent Application Publication
(10) Pub. No.: US 2019/0246038 A1
(43) Pub. Date: Aug. 8, 2019

(54) CAMERA HAVING SUBJECT MAINTENANCE FUNCTION

(71) Applicant: ESSEL-T CO., LTD., Seongnam-si (KR)

(72) Inventor: Shin Ho KIM, Seongnam-si (KR)

(73) Assignee: ESSEL-T CO., LTD.

(21) Appl. No.: 16/008,055

(22) Filed: Jun. 14, 2018

(30) Foreign Application Priority Data
Feb. 2, 2018 (KR) 10-2018-0013498

(51) Int. Cl. H04N 5/232

(52) U.S. Cl. CPC H04N 5/23245; H04N 5/23219; H04N 5/23258; H04N 5/23296

(57) ABSTRACT

Disclosed is a camera having a subject maintenance function, which provides an effect of obtaining better high-quality video by compensating for movement of the camera and compensating so that a moving object is maintained to be a constant size in the center of a screen.

### CROSS-REFERENCE TO RELATED APPLICATION

This application claims priority to and the benefit of Korean Patent Application No. 10-2018-0013498, filed on Feb. 2, 2018, the disclosure of which is incorporated herein by reference in its entirety.

### BACKGROUND

### 1. Field of the Invention

The present invention relates to a camera-related art, and more particularly, to a camera having a subject maintenance function, which maintains a moving object included in a camera image to be a constant size in the center of a screen.

### 2. Discussion of Related Art

Cameras having a video recording function such as an action camera, a smart phone, and the like are generally used, and an optical image stabilization (OIS) function for compensating for shaking of the hand while a camera having a video recording function records is also generally used.

However, it is still difficult to maintain a subject in a central position of a screen when a camera captures a video while following the subject which is moving. To remedy this, high-priced gimbals or a stabilizer is used sometimes.

Gimbals includes a gyro sensor built therein to sense a movement of a user who manipulates a camera, and enables the camera to continuously track a subject by dynamically rotating motors on three axes.

However, since gimbals includes three motors and circuit components and has considerable weight, it is hard for women or children to capture images using gimbals for a long period of time.

Korean Patent Registration No. 10-1316851 (registered on Oct. 2, 2013) discloses small-sized gimbals on which a camera is mounted. The camera, which is designed to be mounted on an unmanned flying vehicle, has a purpose of miniaturizing and integrating gimbals with the camera to be lightened in weight.

The small-sized gimbals drive panning-tilting through a mechanism configured to transmit a driving force of a driving motor to the camera through a plurality of pulleys. As disclosed in the patent document, since the camera has a considerable weight, when the camera is directly driven by a motor, it is necessary to use a heavy motor having relatively high torque. When a small motor is employed, due to low torque thereof, it is necessary to employ a transmission structure such as a gear box or a pulley.

It is a tendency that an imaging module should increase in number of pixels and decrease in volume for reducing a size and weight of a camera. To satisfy the need of increasing the number of pixels, a size of an image sensor pixel is reduced such that a great number of pixels in an image sensor having a limited area are materialized.

According to the tendency, as a pixel size of an image sensor is reduced, a situation frequently occurs in which the definition of a still image is rapidly decreased by a small movement of an imaging module caused by manipulating a shutter when the still image is captured.

Also, in recording a video, even when a pixel size of a sensor is not small, shaking or movement of an image module continuously occurs during recording due to a movement of a user or recording for a long period of time.

Only expert-level users may have image capturing skills which do not cause movement of an imaging device to occur, and a general user experiences unnatural shaking of images between frames in recorded video when recording the video.

Particularly, due to rapid propagation of high definition (HD) TV, it has recently become more common to record HD video. When HD video is recorded, since the number of pixels of the video increases relative to that of standard definition (SD) video, unnatural shaking is more plainly visible in the captured video due to shaking or movement of a user's hand which occur while recording the video. Accordingly, it is not possible to avoid capturing a worse-made low-quality video.

When a moving object is captured while a camera moves, producing better high-quality video to compensate for shaking of the camera and maintaining the moving object to be a constant size in the center of a screen becomes an important issue.

Accordingly, the present inventor has researched a technology of a camera having a subject maintenance function, which is capable of obtaining better high-quality video by compensating for movement of the camera and maintaining a moving object to be a constant size in the center of a screen.

### RELATED ART DOCUMENT

### Patent Documents

Korean Patent Registration No. 10-1316851 (Oct. 2, 2013)

### SUMMARY OF THE INVENTION

The present invention is directed to providing a camera having a subject maintenance function and capable of obtaining a better high-quality video through movement compensation of the camera and compensation by maintaining a moving object to be a constant size in the center of a screen.

The present invention is also directed to a camera having a subject maintenance function and capable of simply changing an image-capturing mode by recognizing a gesture of a moving object.

According to one aspect of the present invention, there is provided a camera having a subject maintenance function. The camera includes a camera portion, a gimbal portion including a plurality of rotating means connected to the camera portion and configured to provide a driving force for rotating the camera portion on pitch, roll, and yaw axes, and a handle portion including a driving controller configured to receive a signal of an angular velocity sensor which senses movements in the three axes of pitch, roll, and yaw and generates a signal corresponding thereto and to control driving of the plurality of rotating means included in the gimbal portion, and including a general controller configured to control a device overall and controls an image-capturing mode of the camera. Here, the general controller includes a moving object recognizer configured to recognize a moving object in a video captured by the camera portion in real time, a driving compensator configured to track the moving object recognized by the moving object recognizer in real time and perform compensation control using real-time driving of the plurality of rotating means provided in the gimbal portion to locate the moving object to the center of a screen, and a zooming portion configured to control real-time zoom of the camera portion to maintain the moving object, located to the center of the screen by the driving compensator, to be a constant size in real time.

The general controller may further include an image-capturing mode changer configured to change the image-capturing mode of the camera portion.

The image-capturing mode may include a foreground first mode in which the entirety of any one object of interest of a plurality of recognized moving objects is maintained to be a first size in the center of the screen and a foreground second mode in which only a part of the any one object of interest of the plurality of recognized moving objects is maintained to be the first size in the center of the screen.

The part of the object of interest may be a face.

The image-capturing mode may further include a foreground third mode in which all of the plurality of recognized moving objects are constantly maintained to be the first size in the center of the screen and a background fourth mode in which all of the plurality of recognized moving objects are constantly maintained to be a second size smaller than the first size in the center of the screen.

The image-capturing mode changer may be embodied to recognize gestures of the moving objects recognized by the moving object recognizer and change the image-capturing mode.

The image-capturing mode changer may be embodied to change the image-capturing mode according to the number of fingers being held up.

The image-capturing mode changer may be embodied to recognize manipulation of a particular button and change the image-capturing mode.

The image-capturing mode changer may be embodied to change the image-capturing mode according to manipulation on a smart phone.

When the image-capturing mode is changed by the image-capturing mode changer, the general controller may track the moving object recognized in the video captured in real time by the camera portion and may control and maintain the moving object to be a constant size in the center of the screen of the mode to which the image-capturing mode was changed, in real time.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a perspective view of a camera having a subject maintenance function according to one embodiment of the present invention;

FIG. 2 is a cross-sectional view illustrating the camera having a subject maintenance function shown in FIG. 1 taken along line A-A′;

FIG. 3 is a plan view of the camera having a subject maintenance function shown in FIG. 1;

FIG. 4 is a separate perspective view illustrating a state in which a battery has been separated from a body portion shown in FIG. 1;

FIG. 5 is a view illustrating operations of the camera having a subject maintenance function shown in FIG. 1;

FIG. 6 is a block diagram illustrating components of a circuit mounted on a printed circuit board according to one embodiment;

FIG. 7 is a block diagram illustrating components of a general controller of the camera having a subject maintenance function according to one embodiment of the present invention; and

FIG. 8A to 8D are views illustrating one example of an image-capturing mode of the camera having a subject maintenance function according to one embodiment of the present invention.

### DETAILED DESCRIPTION OF EXEMPLARY EMBODIMENTS

Hereinafter, exemplary embodiments will be described in detail with reference to the attached drawings to allow those skilled in the art to easily understand and reproduce the present invention. Although particular embodiments are illustrated in the drawings and described in detail in relation thereto, they are not intended to limit a variety of embodiments of the present invention to particular forms.

In describing the present invention, when it is determined that a detailed description of well-known related art may unnecessarily obscure the essential features of the present invention, the detailed description thereof will be omitted.

When it is described that one component is “connected” or “joined” to another component, it should be understood that the one component may be directly connected or joined to the other component but another component may be present therebetween.

On the other hand, when it is described that one component is “directly connected” or “directly joined” to another component, it should be understood that no other component is present therebetween.

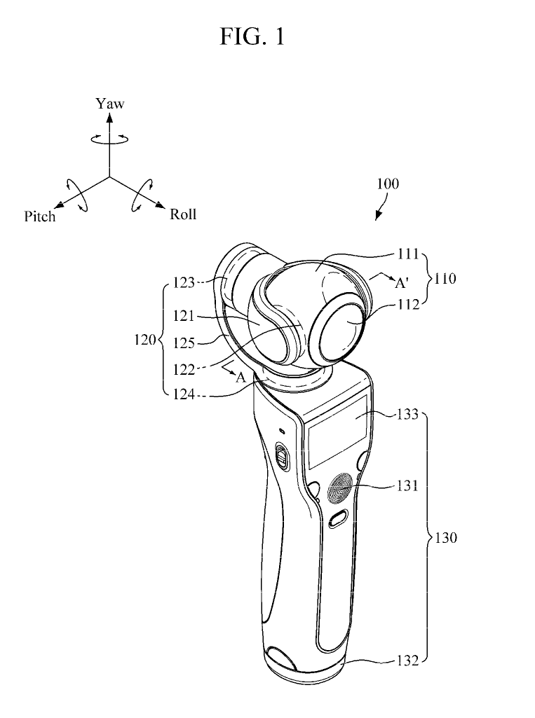

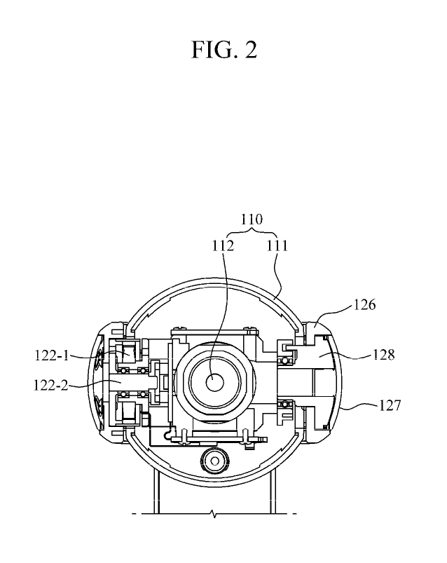

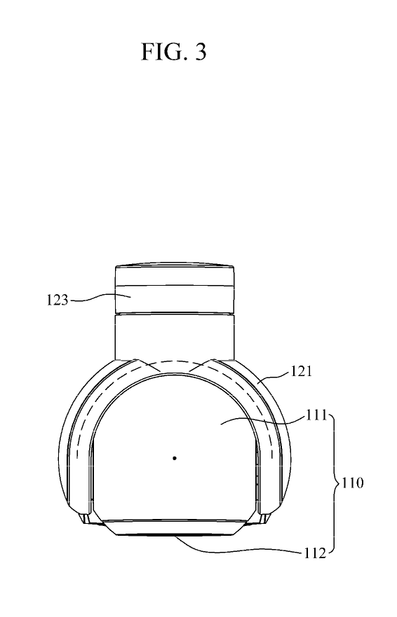

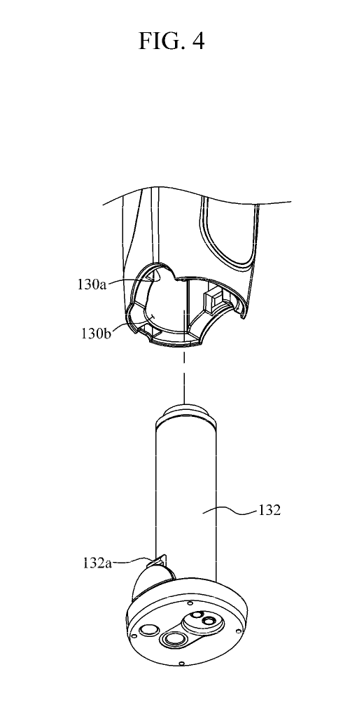

FIG. 1 is a perspective view of a camera having an object-maintenance function according to one embodiment of the present invention, and FIG. 2 is a cross-sectional view illustrating the camera having a subject maintenance function shown in FIG. 1 taken along line A-A′.

Referring to FIG. 1, in a camera 100 having a subject maintenance function according to one aspect, a camera portion 110 and a gimbal portion 120, which rotates the camera portion 110 to continuously track a subject, are integrated with each other. The camera 100 having a subject maintenance function according to one embodiment of the present invention includes the camera portion 110, the gimbal portion 120, and a body portion 130.

In one embodiment, the camera portion 110 includes a commercialized high-functioning camera module built therein. The camera module is a commercialized component which includes a complementary metal-oxide semiconductor (CMOS) image sensor which captures an image, an optical system which includes a plurality of lenses, and a control circuit which controls an actuator which drives the lenses of the optical system for zooming and auto focusing and an optical image stabilization (OIS) actuator which corrects for shaking hands. The camera module includes a basic signal processing circuit built therein and outputs a digitally converted image signal.

A lens 112 which forms a part of the housing is provided on a front part of a housing which covers and protects the camera portion 110. Mechanical components of the camera portion 110 are formed of a light-weight material in consideration of weight lightening. According to one aspect, the camera portion 110 includes an angular velocity sensor which senses a movement of the camera portion 110. In one embodiment, the angular velocity sensor employs a microelectromechanical systems (MEMS) gyro sensor which measures acceleration in each triaxial direction.

The gimbal portion 120 is connected to the camera portion 110 and drives the camera portion 110 to rotate in pitch, roll, and yaw directions. In one embodiment, the gimbal portion 120 includes a pitch motor 122, a roll-pitch connection 121, a roll motor 123, a yaw-roll connection 125, and a yaw motor 124. The roll-pitch connection 121 has one end and another end, which are pivotably coupled to the camera portion 110 by the pitch motor 122 and a hinge shaft 128, respectively, and are pivotably coupled to the roll motor 123 in the rear thereof. As shown in FIG. 2, a part of the pitch motor 122 penetrates and is installed in the camera portion 110. That is, a stator 122-1 of the pitch motor 122 is fixedly installed in the roll-pitch connection 121 and extends to penetrate the inside of the camera portion 110 beyond an area of the roll-pitch connection 121. A shaft 122-2 of the pitch motor 122 is pivotably coupled to the stator 122-1 by two bearings, and one end thereof is fixed to a flange-shaped tool in the camera portion 110. Due to weight lightening of the camera portion 110, although the pitch motor 122 is already small, the pitch motor 122 is installed to span from the camera portion 110 to the gimbal portion 120 such that an outer part of the housing at a pitch connection part of the roll-pitch connection 121 of the gimbal portion 120 may become slimmer.

The hinge shaft 128 includes a through hole in an axial direction therein, and a cable which electrically connects the camera portion 110 to a printed circuit board (PCB) of the body portion 130 passes therethrough.

The roll motor 123 is mounted in the housing in the rear of the roll-pitch connection 121, and an end of a shaft thereof is fixed to one end of the yaw-roll connection 125. A shaft of the yaw motor 124 is fixed to the other end of the yaw-roll connection 125. The yaw motor 124 is mounted on one end of the housing above the body portion 130.

According to one aspect, the camera portion 110 and the gimbal portion 120 have outer surfaces, which at least partially include shapes of portions of a spherical surface, and are coupled to each other to be concentrically arranged. In the embodiment shown in the drawings, an external shape of the camera portion 110 has a spherical shape overall except for surfaces at which the lens portion in the front and the roll-pitch connection 121 on both sides thereof are coupled. Referring to FIG. 2, in the gimbal portion 120, the roll-pitch connection 121 coupled to the camera portion 110 includes a roll-pitch connection housing 126 which has a mechanical support structure and a roll-pitch connection cover 127 which gaplessly covers an outer surface of the roll-pitch connection 121. As shown in FIG. 1, a periphery of a part of the roll-pitch connection cover 127, which is coupled to the camera portion 110, has a shape in accordance with a portion of a spherical surface like the external shape of the camera portion 110. Accordingly, volume is further reduced overall such that a compact and integrated design is obtained.

According to another aspect, all the motors of the gimbal portion 120 are direct drive motors. Since a speed reduction structure is not included, the camera is further decreased in weight such that even a child does not feel uncomfortable while holding the camera for a long period of time to capture a video.

The body portion 130 is fixed to a bottom end of the gimbal portion 120 and has an external shape appropriate for gripping by a user. According to another aspect, the body portion 130 includes a display portion 133 on a top of a front surface and an operation portion 131 which is below the display portion 133 and which includes at least one operation button at a position of a thumb during gripping. A grip portion connected to a bottom of the operation portion 131 as one whole body is included. The grip portion includes a curved surface recessed from a rear surface to improve grip feel.

According to still another aspect, the body portion 130 includes a battery accommodation portion 130b which has an open bottom and a coupling groove 130a formed on one end and a battery 132 which is inserted into the battery accommodation portion 130b and is configured to include a coupling protrusion 132a formed at a position corresponding to the coupling groove 130a. A high-capacity battery may be built in using a grip space of the body portion 130.

According to an additional aspect, PCBs of the camera portion 110 and the body portion 130 may be connected to each other by a micro coaxial cable. An image signal output by the camera module should be transmitted in an uncompressed state to the body portion 130 while the camera portion 110 minimally includes circuits. It is difficult to transmit the image signal using a flexible PCB at such speeds. The micro coaxial cable may transmit uncompressed high-resolution image data without loss. The micro coaxial cable passes from the camera portion 110 to the body portion 130 through the through hole of the hinge shaft 128.

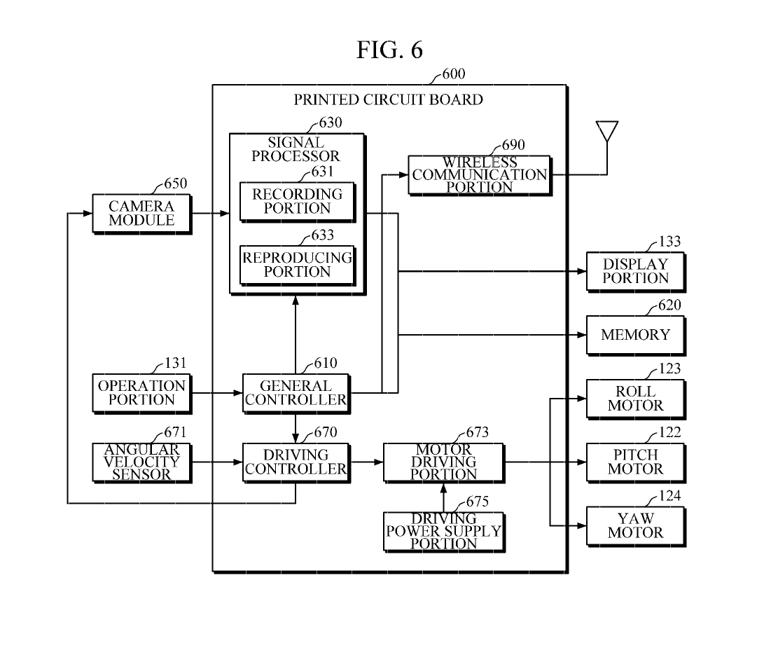

The body portion 130 includes the PCB built therein, on which circuits are mounted. FIG. 6 is a block diagram illustrating components of a circuit mounted on a printed circuit board according to one embodiment. As shown in the drawing, circuits of a driving controller 670, a signal processor 630, and a general controller 610 which controls a device overall are mounted on a PCB 600. The general controller 610 controls the device overall according to firmware stored in a memory 620. According to an input of the operation portion 131, the general controller 610 controls a gimbal operation mode. Also, the general controller 610 controls the signal processor 630 according to the input of the operation portion 131. The general controller 610 displays information on a current operation on the display portion 133.

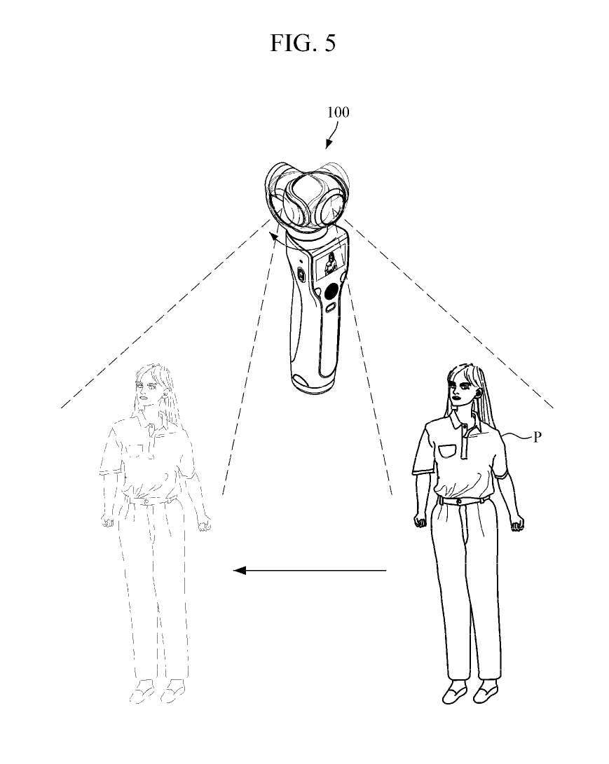

The driving controller 670 detects three axis movements of the camera portion 110 from a signal of an angular velocity sensor 671, reflects a degree of movement on each axis, and drives a corresponding motor of the gimbals according to an operation mode set by the general controller 610. The gimbals may maintain the camera in a current direction and may operate to track a subject at a certain distance. According to one aspect, a motor driver 673 controls zooming and focusing of the camera module 650 in connection with the gimbals to track a subject. Accordingly, it is possible to capture an image of the subject such that the subject has a constantly constant size on a screen. As shown in FIG. 5, to track a subject P while maintaining a constant size and a constant position on a screen, it is necessary to interwork with zooming and focusing of the camera module in addition to the gimbals. Also, it is advantageous that the camera having a subject maintenance function, which experiences drastic movement, accompanies an OIS function. The driving controller 670 may independently control three axis motors and four control parameters of zooming at the same time using four-channel output. The motor driver 673 has three channels and controls displacement of the three motors 122, 123, and 124 by switching driving power supplied by a driving power supply portion 675 through an H-bridge circuit.

According to one aspect, the signal processor 630 may include a recording portion 631 which compresses and stores an image, which is output by the camera module 650, in the memory 620. In one embodiment, the memory 620 is configured as a flash memory and stores firmware for controlling operation of the device, and content data which includes a video, and meta data. According to an additional aspect, the signal processor 630 may further include a reproducer 633 which displays an image obtained by decoding the image stored in the memory 620 or the image output by the camera module 650 on the display portion 133. The display portion 133 may reproduce a currently captured image in real time or may reproduce a recorded image. In the embodiment shown in the drawing, the display portion 133 may be configured as a liquid crystal display (LCD), an organic light emitting diode (OLED) display, or an electronic paper display.

According to still another aspect, the circuit of the PCB may further include a wireless communication portion 690. The wireless communication portion 690 may transmit an image captured in real time or a stored recorded image to an external terminal, such as a display worn on a wrist or a cloud server at a remote site through an access point.

The signal processor 630 includes a digital signal processor and a coder-decoder (CODEC) and is embodied as a system-on-chip (SOC) with the general controller 610 and the wireless communication portion 690. Although not shown in the drawing, the PCB 600 includes a display control circuit, which drives the display portion 133, as a part of the SOC.

The driving controller 670 receives a signal of the angular velocity sensor 671 which senses triaxial movements of pitch, roll, and yaw and generates a signal corresponding thereto and performs stabilizing by controlling and driving the pitch motor 122, the roll motor 123, and the yaw motor 124, which are a plurality of rotating means included in the gimbal portion 120.

The driving controller 670 calculates a control value for moving the camera portion 110 to compensate for a rotational movement of the camera portion 110 sensed by the angular velocity sensor 671 and controls the motor driver 673 to rotate the pitch motor 122, the roll motor 123, and the yaw motor 124, which are rotating means.

To compensate for shaking hands or shaking of the camera portion 110, the driving controller 670 may rotate the pitch motor 122, the roll motor 123, and the yaw motor 124 in a direction opposite to a direction of shaking of the hands or the camera portion 110 sensed by the angular velocity sensor 671.

The general controller 610 identifies an object to be image-captured and focuses on the identified object to capture an image of the object while tracking the object. That is, when the identified object moves, a command is given to the driving controller 670 to control and drive the pitch motor 122, the roll motor 123, and the yaw motor 124, which are rotating means.

Accordingly, the driving controller 670 controls the motor driver 673 to rotate the camera portion 110 in pitch, roll, and yaw axes directions such that the camera portion 110 captures an image while the focus of the camera portion 110 is fixed on the object (an object of movement).

Additionally, the general controller 610 controls the device overall and controls an image-capturing mode of the camera. For example, the general controller 610 may change the image-capturing mode of an image-capturing module (not shown) according to a gesture of the object.

For example, when the object clenches his or her fist, the general controller 610 recognizes the first of the object and gives a zoom-in command to the image-capturing module (not shown) such that the object may be magnified and image-captured.

As another example, when the object opens his or her hand, the general controller 610 recognizes a palm of the object and gives a zoom-out command to the image-capturing module such that the object may be made smaller and image-captured.

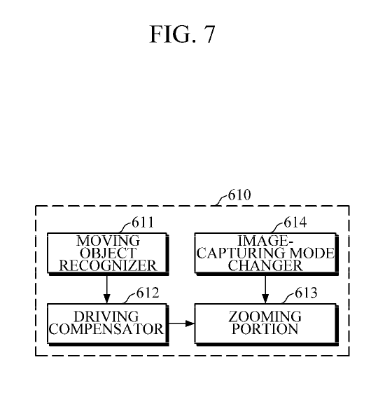

FIG. 7 is a block diagram illustrating components of the general controller of the camera having a subject maintenance function according to one embodiment of the present invention. The general controller 610 according to the embodiment includes a moving object recognizer 611, a driving compensator 612, and a zooming portion 613.

The moving object recognizer 611 recognizes a moving object in an image captured by the camera portion 110 in real time. Here, a moving object recognition method has been an art already well-known before the filing of this application. For example, the moving object recognizer 611 may be embodied to recognize objects in a series of images on the basis of feature point analysis and detect a change in coordinates of feature points of the recognized object to recognize a moving object.

The driving compensator 612 tracks the moving object recognized by the moving object recognizer 611 in real time and controls and compensates using real-time driving of the pitch motor 122, the roll motor 123, and the yaw motor 124, which are a plurality of rotating means provided at the gimbal portion 120 such that the moving object is located to the center of a screen.

For example, the driving compensator 612 may analyze a series of image frames in real time, track whether the moving object deviates from the center of the screen, and when the moving objects deviates from the center of the screen, control the moving object to remain in the center of the screen by rotating the pitch motor 122, the roll motor 123, and the yaw motor 124, which are rotating means, by a distance of separation in a direction opposite to that in which the moving object has deviated.

The general controller 610 gives a command to the driving controller 670 to perform movement stabilizing compensation of the camera and simultaneously perform additional compensation for continuously maintaining the moving object to be in the center of the screen. According to the command, the driving controller 670 drives the motor driver 673 to drive and rotate the pitch motor 122, the roll motor 123, and the yaw motor 124, which are a plurality of rotating means included in the gimbal portion 120, in real time.

The zooming portion 613 controls real-time zoom of the camera portion 110 to maintain the moving object, located to the center of the screen by the driving compensator 612, to be a constant size in real time.

First, a size of the moving object is detected. Here, in a mode in which an overall shape of the object is displayed, an overall size is detected. In a mode in which a part, for example, of a face is largely displayed on the screen, a size of the face is detected.

Afterwards, when the size of the moving object located in the center of the screen is less than a preset size, the zooming portion 613 transmits a zoom-in command to the signal processor 630 to capture an image of the moving object using the camera portion 110 such that the moving object is magnified to be the preset size by zooming in a video in which the moving object is being maintained to be in the center of the screen in real time by the driving compensator 612.

On the other hand, when the size of the moving object located in the center of the screen is more than a preset size, the zooming portion 613 transmits a zoom-out command to the signal processor 630 to capture an image of the moving object using the camera portion 110 such that the moving object is made smaller to be the preset size by zooming out in the video in which the moving object is being maintained to be in the center of the screen in real time by the driving compensator 612.

Embodied as described above, when a user who holds the camera having a subject maintenance function tracks and captures an image of a moving object that is a subject for capture, an effect of obtaining a better high-quality video through movement compensation of the camera and compensation for maintaining the moving object to be a constant size in the center of a screen is provided.

According to an additional aspect of the present invention, the general controller 610 may further include an image-capturing mode changer 614. The image-capturing mode changer 614 changes an image-capturing mode of the camera portion 110.

For example, the image-capturing mode may include a foreground first mode in which the entirety of any one object of interest of a plurality of recognized moving objects is maintained to be a first size in the center of the screen and a foreground second mode in which only a part of the any one object of interest of the plurality of recognized moving objects is maintained to be the first size in the center of the screen. Here, a part of a moving object of interest may be a face.

For example, the image-capturing mode may further include a foreground third mode in which all of the plurality of recognized moving objects are constantly maintained to be the first size in the center of the screen and a background fourth mode in which all of the plurality of recognized moving objects are constantly maintained to be a second size smaller than the first size in the center of the screen.

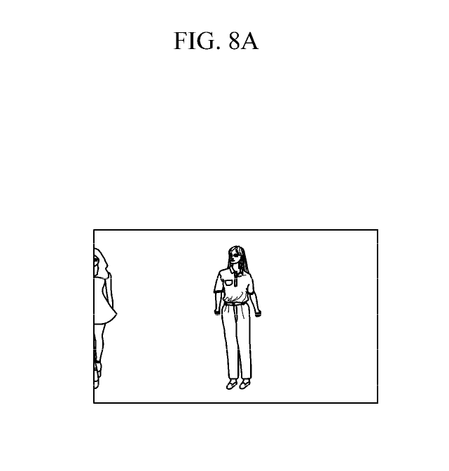

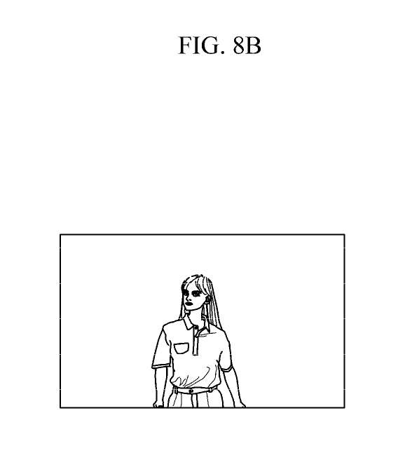

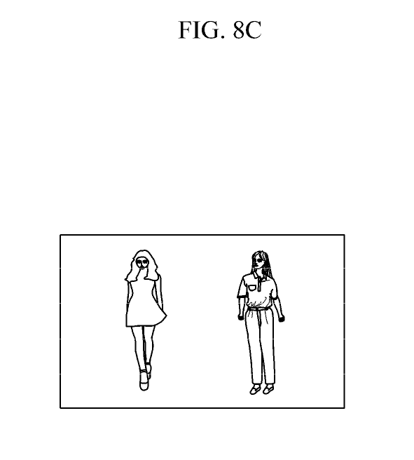

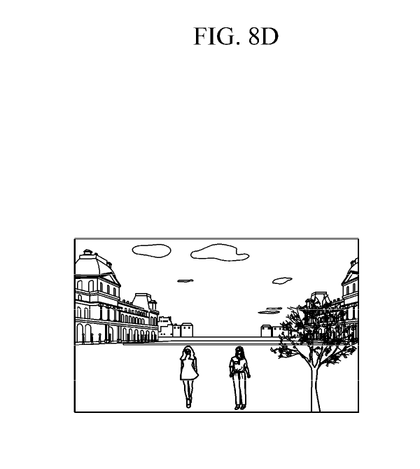

FIGS. 8A to 8D are views illustrating one example of the image-capturing mode of the camera having a subject maintenance function according to one embodiment of the present invention. FIG. 8A illustrates a screen of the foreground first mode in which the entirety of any one object of interest of a plurality of recognized moving objects is maintained to be the first size in the center of the screen, and FIG. 8B illustrates a screen of the foreground second mode in which only a part of any one object of interest of a plurality of recognized moving objects is maintained to be the first size in the center of the screen.

FIG. 8C illustrates a screen of the foreground third mode in which all of the plurality of recognized moving objects are constantly maintained to be the first size in the center of the screen, and FIG. 8D illustrates a screen of the background fourth mode in which all of the plurality of recognized moving objects are constantly maintained to be the second size smaller than the first size in the center of the screen.

When the image-capturing mode changer 614 changes an image-capturing mode, the general controller 610 tracks a moving object recognized in a video captured in real time by the camera portion 110 and controls and maintains the moving object to be a certain size in the center of a screen of the mode to which the image-capturing mode was changed, in real time.

For this, the general controller 610 recognizes the moving object in the video captured by the camera portion 110 in real time through the moving object recognizer 611, adjusts the recognized moving object to be in the center of the screen through the driving compensator 612, and controls zooming of the camera portion 110 through the zooming portion 613 to maintain the moving object to be a constant size in real time in the center of the screen of the mode to which the image-capturing mode was changed.

According to an additional aspect of the present invention, the image-capturing mode changer 614 may be embodied to recognize gestures of the moving objects recognized by the moving object recognizer 611 and change the image-capturing mode.

For example, when the gesture recognized by the moving object recognizer 611 is a gesture of clenching a fist, the image-capturing mode may be changed to the foreground first mode in which the entirety of the moving object of interest which clenches a first among the plurality of recognized moving objects is constantly maintained to be the first size in the center of the screen.

For example, when the gesture recognized by the moving object recognizer 611 is a gesture of making a V shape using the fingers, the image-capturing mode may be changed to the foreground second mode in which a part of the moving object of interest which makes a V shape using the fingers among the plurality of recognized moving objects is constantly maintained to be the first size in the center of the screen.

For example, when the gesture recognized by the moving object recognizer 611 is a gesture of showing a palm, the image-capturing mode may be changed to the foreground third mode in which all of the plurality of recognized moving objects are constantly maintained to be the first size in the center of the screen.

For example, when the gesture recognized by the moving object recognizer 611 is a gesture of shaking a hand, the image-capturing mode may be changed to the background fourth mode in which all of the plurality of recognized moving objects are constantly maintained to be the second size smaller than the first size in the center of the screen.

The image-capturing mode may be changed according to the number of spread-out fingers recognized by the moving object recognizer 611.

For example, when the gesture recognized by the moving object recognizer 611 is a gesture of holding up one finger, the image-capturing mode may be changed to the foreground first mode in which only a person who is holding up one finger is constantly maintained to be the first size in the center of the screen.

For example, when the gesture recognized by the moving object recognizer 611 is a gesture of making a circle with the fingers, the image-capturing mode may be changed to the foreground second mode in which only the face of a person who is making a circle with their fingers is constantly maintained to be the first size in the center of the screen.

According to an additional aspect, the image-capturing mode changer 614 may be embodied to recognize manipulation of a particular button and change the image-capturing mode. For example, whenever a user pushes the operation portion 131 once, the image-capturing mode may be sequentially changed from the first mode to the second mode, from the second mode to the third mode, from the third mode to the fourth mode, and from the fourth mode back to the first mode.

According to an additional aspect, the image-capturing mode changer 614 may be embodied to recognize manipulation on a smart phone and change the image-capturing mode. For example, the camera 100 having a subject maintenance function according to one aspect of the present invention may be embodied to be connected through short-range wireless communication to a smart phone (not shown) accompanying the user through a wireless communication portion 690 such as Bluetooth module and the like, to provide a video in which a moving object is constantly maintained to be in the center of a screen in real time to the smart phone, and to change an image-capturing mode according to manipulation by the user such as touching a button and the like using the image-capturing mode changer 614.

As described above, according to the embodiments of the present invention, since it is possible to capture an image while simply changing an image-capturing mode through recognition of a gesture of a moving object included in a video, manipulation of a button or a smart phone, and the like, user convenience may be increased.

As described above, according to the embodiments of the present invention, a better high-quality video may be obtained through movement compensation of the camera and compensation for maintaining a moving object to be a constant size in the center of a screen, and an image-capturing mode may be simply changed by recognizing a gesture of a moving object included in a video such that the above aspects may be obtained.

At least some of apparatuses (for example, modules or functions thereof) or methods (for example, operations) according to a variety of embodiments of the present invention may be executed by instructions stored in computer-readable storage media such as programming modules.

When an instruction is executed by one or more processors, one or more processors may perform a function corresponding to the instruction. At least some of the programming modules may be implemented (for example, executed) by a processor. At least some of the programming modules may include, for example, a module, a program, a routine, sets of instructions, a process, or the like for performing one or more functions.

According to the embodiments of the present invention, provided is an effect of obtaining a better high-quality video through movement compensation of the camera and compensation for maintaining a moving object to be a constant size in the center of a screen.

Also, since it is possible to simply change an image-capturing mode by recognizing a gesture of a moving object included in a video, an effect of increasing user convenience is provided.

Also, a variety of embodiments described and illustrated in the specification and the drawings are merely examples and are not intended to limit the scope of the present invention.

Accordingly, it should be understood that the scope of the present invention includes all changes or modifications derived on the basis of the technical concept of the present invention in addition to the above-described embodiments.

What is claimed is:

1. A camera having a subject maintenance function, comprising:
a camera portion;
a gimbal portion comprising a plurality of rotating means connected to the camera portion and configured to provide a driving force for rotating the camera portion on pitch, roll, and yaw axes; and
a handle portion including a driving controller which performs a stabilizing function by receiving a signal of an angular velocity sensor which senses movements in the three axes of pitch, roll, and yaw and generates a signal corresponding thereto and controlling driving of the plurality of rotating means provided in the gimbal portion, and a general controller configured to control a device overall and an image-capturing mode of the camera,
wherein the general controller comprises:
a moving object recognizer configured to recognize a moving object in a video captured by the camera portion in real time;
a driving compensator configured to track the moving object recognized by the moving object recognizer in real time and perform compensation control for the real-time driving of the plurality of rotating means included in the gimbal portion to locate the moving object to the center of a screen; and
a zooming portion configured to control real-time zoom of the camera portion to maintain the moving object, located to the center of the screen by the driving compensator, to be a constant size in real time.

2. The camera of claim 1, wherein the general controller further comprises an image-capturing mode changer configured to change the image-capturing mode of the camera portion.

3. The camera of claim 2, wherein the image-capturing mode comprises:
a foreground first mode in which the entirety of any one moving object of interest of a plurality of recognized moving objects is maintained to be a first size in the center of the screen; and
a foreground second mode in which only a part of the any one moving object of interest of the plurality of recognized moving objects is maintained to be the first size in the center of the screen.

4. The camera of claim 3, wherein the part of the moving object of interest is a face.

5. The camera of claim 3, wherein the image-capturing mode further comprises:
a foreground third mode in which all of the plurality of recognized moving objects are constantly maintained to be the first size in the center of the screen; and
a background fourth mode in which all of the plurality of recognized moving objects are constantly maintained to be a second size smaller than the first size in the center of the screen.

6. The camera of claim 2, wherein the image-capturing mode changer recognizes gestures of the moving objects recognized by the moving object recognizer and changes the image-capturing mode.

7. The camera of claim 6, wherein the image-capturing mode changer changes the image-capturing mode according to the number of fingers of an open hand.

8. The camera of claim 2, wherein the image-capturing mode changer recognizes manipulation on a particular button and changes the image-capturing mode.

9. The camera of claim 2, wherein the image-capturing mode changer changes the image-capturing mode according to manipulation on a smart phone.

10. The camera of claim 2, wherein when the image-capturing mode is changed by the image-capturing mode changer, the general controller tracks the moving object recognized in the video captured in real time by the camera portion and controls and maintains the moving object to be a constant size in the center of the screen of the mode to which the image-capturing mode has been changed, in real time.
